(19) United States
(12) Patent Application Publication
(10) Pub. No.: US 2010/0313242 A1
(43) Pub. Date: Dec. 9, 2010

(54) NETWORK MANAGEMENT METHOD, NETWORK MANAGEMENT PROGRAM, NETWORK SYSTEM, AND INTERMEDIATE DEVICE

(75) Inventor: Takayuki Sato, Tokyo (JP)

Correspondence Address: INTELLECTUAL PROPERTY / TECHNOLOGY LAW, PO BOX 14329, RESEARCH TRIANGLE PARK, NC, 27709, US

(73) Assignee: ALLIED TELESIS HOLDINGS K.K., Tokyo (JP)

(21) Appl. No.: 12/793,671

(22) Filed: Jun. 3, 2010

(30) Foreign Application Priority Data
Jun. 4, 2009 (JP) 2009-135338

(51) Int. Cl. H04L 9/32

(52) U.S. Cl. 726/3

(57) ABSTRACT

A network management method is performed in a computer network system which includes a network device, a network management device managing the network device, and an intermediate device connecting the network device with the network management device. In the method, the network management device stores in advance an authenticated account for authenticating the network device. The intermediate device instructs the network device to prompt a user to enter a user account, acquires the user account and device identification information relating to the network device from the network device, and transmits the user account and the device identification information to the network management device. The network management device performs an authentication process for the network device based on the authentication accounts and the user account, and stores the device identification information as authentication device identification information if the network device is authenticated in the first authentication process.

### CROSS-REFERENCES TO RELATED APPLICATIONS

This application relates to and claims priority from Japanese Patent Application No. 2009-135338, filed on Jun. 4, 2009, the entire disclosure of which is incorporated herein by reference.

### Background

1. Field of the Invention

This invention relates generally to a network management method, a network management program, a network system, and an intermediate device. The present invention particularly relates to a network management method, a network management program, a network system, and an intermediate device, which are capable of configuring a simple and highly-secure MAC (Media Access Control) address-based VLAN (Virtual Local Area Network).

2. Description of Related Art

Conventionally, a system in which a network management device or intermediate device that configures a MAC address-based VLAN includes a database in which MAC addresses and VLAN groups associated with one another are stored, recognizes a VLAN group based on a source MAC address in packets received from a network device, and determines a VLAN group for the network device, is known. Such a system is disclosed in, for example, JP 3784269 B2.

It is important for persons who manage or use such a system to minimize human-induced processes and to realize high-level security environment capable of preventing unauthorized access from the outside.

An object of this present invention is to provide a network management method, a network management program, a network system, and an intermediate device that are capable of solving the above-described problems. The object will be attained by features recited in the independent claims of the Claims. The dependent claims will set forth further advantageous instances of this invention.

### SUMMARY

According to an aspect of this invention, a network management method is performed in a computer network system which includes a network device, a network management device managing the network device, and an intermediate device connecting the network device with the network management device. In the method, the network management device stores in advance an authenticated account for authenticating the network device. The intermediate device instructs the network device to prompt a user to enter a user account, acquires the user account and device identification information relating to the network device from the network device, and transmits the user account and the device identification information to the network management device. The network management device performs an authentication process for the network device based on the authentication accounts and the user account, and stores the device identification information as authentication device identification information if the network device is authenticated in the first authentication process.

Accordingly, since a network management device stores device identification information on the condition that a network device is authenticated based on authentication accounts and a user account, the method of the present invention can prevent unauthorized access until device identification information is stored and also avoid hassle of registration of device identification information about network devices in advance. Therefore, a simple and highly-secure network management method can be provided.

The method may further include: after the storing of the device identification information, acquiring, by the intermediate device, device-to-be-authenticated identification information from the network device, the device-to-be-authenticated identification information being device identification information about the network device; transmitting, by the intermediate device, the device-to-be-authenticated identification information to the network management device; and performing, the network management device, a second authentication process for the network device based on the authentication device identification information and the device-to-be-authenticated identification information.

Further, the method may further include: prior to the acquisition of the device-to-be-authenticated identification information, requesting, by the network device, the intermediate device to perform the second authentication process in the network management device.

In the method, the storing of the authentication account may include storing the authentication account in association with a predetermined VLAN group. The method may further include, after the second authentication process, setting, by the network management device, if the network device is authenticated, a VLAN group for the network device.

In the method, the instruction of the intermediate device is performed when the network device requests the intermediate device to perform the first authentication process in the network management device.

In the method, the authenticated account may be an account shared by a plurality of users.

In the method, the device identification information may be a MAC address of the network device.

The present invention may relate to a network management program including instructions to cause a computer to perform the network management method as discussed above.

According to an aspect of the present invention, a network system comprises a network device, a network management device configured to manage the network device, and an intermediate device configured to operatively connect the network device and the network management device. The intermediate device includes an instruction unit configured to instruct the network device to prompt a user to enter a user account, an acquisition unit configured to acquire the user account and device identification information about one of the network devices from the network device, and a transmission unit configured to transmit the user account and the device identification information to the network management device. The network device includes an authenticated account storage unit configured to store an authentication account used for authenticating the network device, a first authentication execution unit configured to authenticate the network device based on the authentication account and the user account, and an authentication device identification information storage unit configured to store the device identification information as authentication device identification information if the network device is authenticated by the first authentication execution unit.

Accordingly, since a network management apparatus stores device identification information on the condition that a network device is authenticated based on authentication accounts and a user account, the method of the present invention can prevent unauthorized access until device identification information is stored and avoid hassle of registration of device identification information about network devices in advance. Therefore, a simple and highly-secure network management method can be provided.

In the system, the acquisition unit of the intermediate device may acquire device-to-be-authenticated identification information from the network device, the device-to-be-authenticated identification information being device identification information about the network device. Further, the network management device may further include a second authentication execution unit configured to authenticate the network device based on the authentication device identification information and the device-to-be-authenticated identification information.

According to an aspect of the present invention, an intermediate device connecting a network device and a network management device which manages the network device, the intermediate device comprises an authenticated account storage unit configured to store an authentication account used for authenticating the network device, an instruction unit configured to instruct the network device to prompt a user to enter a user account, an acquisition unit configured to acquire the user account and device identification information about the network device from the network device, a first authentication execution unit configured to authenticate the network device based on the authentication account and the user account, and an authentication device identification information storage unit configured to store the device identification information as authentication device identification information if the network device is authenticated by the first authentication execution unit.

Accordingly, since an intermediate device stores device identification information on the condition that a network device is authenticated based on authentication accounts and a user account, the method of the present invention can prevent unauthorized access until device identification information is stored, and avoid hassle of registration of device identification information about network devices in advance. Therefore, a simple and highly-secure network management method can be provided.

In the intermediate device, the acquisition unit may acquire device-to-be-authenticated identification information from the network device, the device-to-be-authenticated identification information being device identification information about the relevant network device. The network management device may further include a second authentication execution unit configured to authenticate the network device based on the authentication device identification information and the device-to-be-authenticated identification information.

Other aspects and advantages of the invention will be apparent from the following description and the appended claims.

### BRIEF DESCRIPTION OF THE DRAWINGS

FIG. 1 is a diagram for showing a network system according to an embodiment of this invention.

FIG. 2 is a diagram for showing a hardware configuration of a network management device according to an embodiment of this invention.

FIG. 3 is a diagram for showing a configuration of a network system according to an embodiment of this invention.

FIG. 4 is a sequence diagram for illustrating a network management method according to an embodiment of this invention.

FIG. 5 is a diagram for showing a database stored in a network management device according to an embodiment of this invention.

FIG. 6 is a flowchart of a network management method according to an embodiment of this invention.

FIG. 7 is a flowchart of a network management method according to an embodiment of this invention.

FIG. 8 is a diagram of a configuration of an intermediate device according to another embodiment of this invention.

### DETAILED DESCRIPTION OF PREFERRED EMBODIMENTS

The present invention will be explained below using embodiments of the invention with reference to the drawings, but the following embodiments do not limit the claimed invention, and not all of the combinations of features explained in the embodiments are required as the solution of the invention.

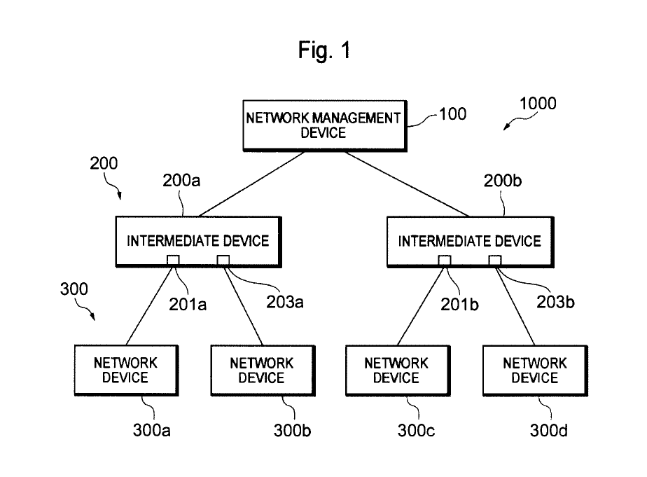

FIG. 1 is a diagram for showing a computer network system according to an embodiment of this invention. A computer network system 1000 includes, network devices 300a-300d, a network management device 100, which manages the network devices 300a-300d, and intermediate devices 200a and 200b, each of which operatively connects ones of the network devices 300a-300d with the network management device 100.

The network devices 300a-300d may be, for example, general-purpose computer terminals. Also, the network device 300a-300d may be devices that positively access (e.g., requesting authentication) the intermediate devices 200a and 200b or the network management device 100, or may be devices, such as network printers, etc., which do not positively access the intermediate devices 200a and 200b or the network management device 100.

The network management device 100 receives a MAC address, which is an example of device identification information transmitted from the network devices 300a-300d, via the intermediate devices 200a and 200b. Further, the network management device 100 receives user accounts entered into the network devices 300a-300d via the intermediate devices 200a and 200b, and transmits the result of authentication to the network devices 300a-300d via the intermediate devices 200a and 200b.

The network management device 100 determines VLAN groups for the network devices 300a-300d. Further, the network management device 100 enables the network devices 300a-300d to communicate on respective VLAN groups by designating connection ports 201a, 203a, 201b, and 203b of the intermediate devices 200a and 200b to the relevant VLAN group to which each of the network devices 300a-300d belongs.

The intermediate devices 200a and 200b may be wireless intermediate devices communicating to the network devices 300a-d without wires. Configuring a MAC address-based VLAN in a computer network system including wireless intermediate devices allows network devices to communicate on predetermined VLAN groups without changing their settings even when the location where the network device is used is changed.

Aside from the example shown in FIG. 1, another intermediate device which connects the network management device 100 and the intermediate devices 200a and 200b or another intermediate device which connects the intermediate devices 200a and 200b and the network devices 300a-300d, may also be employed.

Further, by settings to allow, for example, the connection ports 201a and 203a to communicate on a plurality of VLANs (e.g., VLAN1 and VLAN2), the network devices 300a and 300b connected to the intermediate device 200a may communicate on VLAN1 and/or VLAN2

Furthermore, a computer network system according to the embodiment may add a tag for identifying a VLAN to an Ethernet frame. Thus, a tagging LAN, which divides a VLAN based on tag information, or a multiple LAN, which allows an arbitrary port to belong to one or more VLAN groups, may be used in combination with a MAC VLAN in the embodiment.

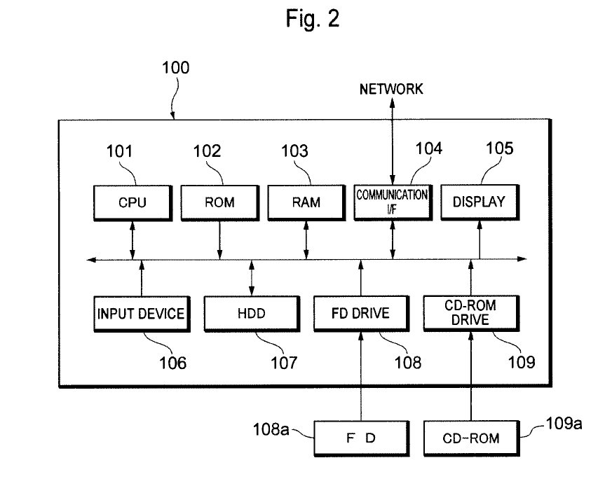

FIG. 2 is a diagram for showing a hardware configuration of the network management device 100 according to the embodiment. A computer provided with, as shown in FIG. 2, for example, a CPU 101, a ROM 102; a RAM 103, a communication I/F 104, a display 105, an input device 106, an HDD 107, an FD drive 108, and a CD-ROM drive 109, may be adapted for the network management device 100.

The CPU 101 of the network management device 100, for example, executes a predetermined program (a program defining the network management method according to the present invention) stored in the ROM 102, the RAM 103 or the external storage device 107, or downloaded via a network, thereby allowing the system 1000 to provide various functional blocks or various steps as described below. The stored or downloaded program may be in compression or in uncompression. The program are installed from the storage medium or the memory to the HDD 107, loaded into the RAM 103, and then executed by the CPU 101. Processes performed by the CPU 101 of the computer executing the program defining the network management method according to the embodiment are the same as functions of corresponding members in the system or the method of the embodiment, respectively.

A part or all of the functions of the system 1000 in embodiments described in the present application may be stored in the FD 108a or CD-ROM 109a as an example of a storage medium as shown in FIG. 2.

The program may be read out directly from the storage medium and loaded to the RAM, and then executed, or otherwise may be loaded to the RAM and then executed after installed in a hard disk drive. The program may be stored in a storage medium or media. Further, the program may be stored in an encoded form.

In addition to an FD and a CD-ROM, a DVD, an optical storage medium, such as a PD, a magnet-optical recording media, such as an MO, a tape recording medium, a magnetic recording medium, or a semiconductor memory, such as an IC card or miniature card, may be used as a storage medium. Furthermore, a storage device, such as a hard disk drive or RAM provided in a server system connected on a private communication network or the Internet may be used as a recording medium, and thereby the program may be provided to a system via such a network. Such a storage medium is used only for configuring a system, and thus any manufacture, sale, etc., of the storage medium as business will obviously constitute an infringement of the patent for the present application.

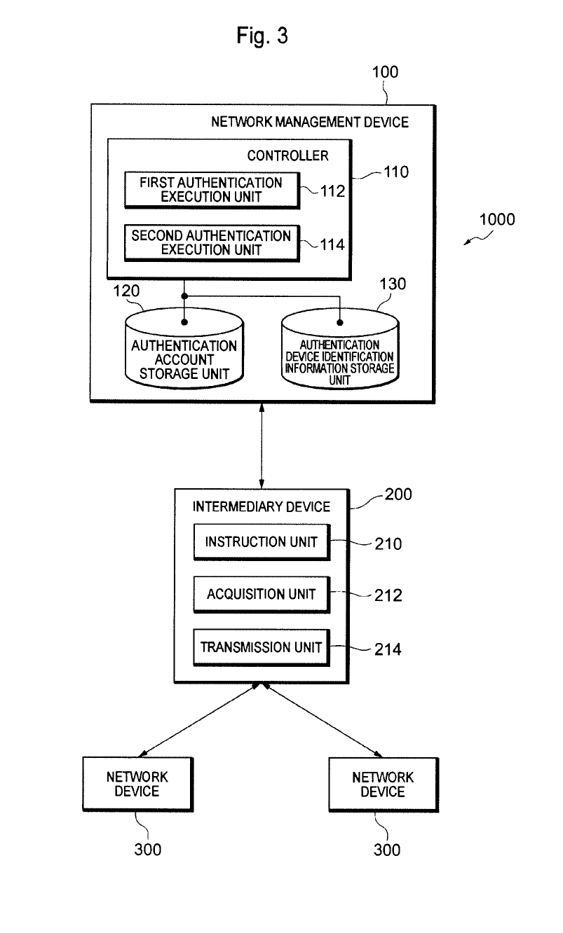

FIG. 3 is a diagram for showing a configuration of the system 1000 according to the embodiment. In an example shown in FIG. 3, the network management device 100 comprises a controller 110 which performs necessary data transmission and reception to/from the intermediate device 200 and performs necessary control for executing the network management method according to the embodiment, an authentication account storage unit 120 which stores in advance authentication accounts used for authenticating user accounts entered by users, and an authenticated device identification information storage unit 130 which stores authentication device identification information used for authenticating device-to-be-authenticated identification information regarding the network device 300. The controller 110 is configured to read out data from each storage unit, and write data to each storage unit.

The authentication account storage unit 120 stores predetermined authentication accounts determined by an administrator. An authentication account may be available for the device identification information in each of the network devices 300. In other words, with respect to one authentication account, a plurality of datasets of the device identification information may be associated. Further, the authentication account may be stored in the authentication account storage unit 120 in association with a predetermined VLAN group to which the network device 300 belongs. In this case, the authentication account storage unit 120 may include a database in which user IDs, passwords, and VLAN IDs are associated with one another. By way of registering an authentication account for each of VLAN groups to which the network devices belong, the relevant VLAN can be assigned to a specific network device for the authentication account which a user logs in, and accordingly it is possible to manage VLAN groups easily. The authentication account may be shared by plural users. Alternatively, the authentication account may be defined per user.

The authentication device identification information storage unit 130 stores a MAC address, which is an example of device identification information about a network device. The MAC address stored in the authentication device identification information storage unit 130 is used for authenticating the network device 300, and thus the MAC address can be called an authentication MAC address. The authentication device identification information storage unit 130 may create a user ID and a password based on the authentication MAC address. The authentication device identification information storage unit 130 may store the authentication MAC address in association with an authentication account. In this case, the authentication MAC address may be stored to be associated directly with an authentication account. Alternatively, the authentication MAC address may be stored to be associated indirectly with an authentication account; namely, the authentication MAC address may be associated with a VLAN ID which corresponds to an authentication account.

The intermediate device 200 includes an instruction unit 210 which instructs the network device 300 to prompt a user to enter a user account. The instruction unit 210 performs a process, when the network device 300 requests the intermediate device 200 to conduct an authentication in the network management device 100 based on an authentication account and a user account. More specifically, the intermediate device 200 transmits data regarding a login screen to the network device 300, when the relevant intermediate device 200 is accessed (e.g., via a Web browser) from the network device 300. Namely, the intermediate device 200 instructs the network device 300 to prompt a user to undergo a web site authentication process.

The intermediate device 200 further includes an acquisition unit 212 which acquires a user account entered by user and device identification information on the network device 300 from the network device 300, and a transmission unit 214 which transmits a user account entered by a user and device identification information on the network device 300 to the network management device 100.

A first authentication execution unit 112 of the network management device 100 executes a first authentication process based on a user account entered into the network device 300 and authentication accounts stored in advance in the authenticated account storage unit 120. More specifically, the first authentication execution unit 112 reads out the authentication accounts stored from the authentication account storage unit 120, and determines whether or not any of the authenticated accounts corresponds to the user account entered in to the network device 300. As a result, If the first authentication execution unit 112 determines that the both accounts are met, the first authentication execution unit 112 determines that the access is a valid access authorized in advance by an administrator, receives a MAC address of the network device 300 via the intermediate device 200, and then stores the MAC address in the authentication device identification information storage unit 130 as an authentication MAC address. In this case, the authentication MAC address is stored in association with the authentication account. Furthermore, if the access is successfully authenticated, the first authentication execution unit 112 informs intermediate device 200 and the network device 300 of this fact.

Further, a second authentication execution unit 114 of the network management device 100 performs a process when the network device 300 requests the intermediate device 200 to conduct an authentication process in the network management device 100 based on an authentication MAC address and a to-be-authentication MAC address. In other words, the second authentication execution unit 114 executes a so-called MAC address-based authentication on the network device 300, when the network device 300 accesses the network management device 100 (e.g., by using an arbitrary protocol). If the second authentication execution unit 114 determines that the both MAC addresses correspond to each other, the second authentication execution unit 114 determines that the access is a valid access, and informs the intermediate device 200 and the network device 300 that the access is successfully authenticated. The second authentication execution unit 114 then determines a VLAN group associated with the to-be-authenticated MAC address for the network device 300, and authorizes subsequent communications based on the relevant VLAN group.

According to the system in the present embodiment, since a user logs into his/her account, and then a MAC address of the logged-in network device is stored as an authentication MAC address used for a MAC address-based authentication, it is possible to execute a MAC address-based authentication process without further entry of a MAC address by the user. Thus, a network administrator can easily configure a MAC address-based VLAN without registering in advance MAC addresses of network devices in a network management device. Meanwhile, since in order to store a MAC address of a network device, the account should be authenticated when logged in, it is possible to prevent an unauthorized access to a VLAN. In other words, the level of security during the period in which a MAC address is stored as an authenticated MAC address used for a MAC address-based authentication can be improved.

Furthermore, it is enough for an administrator to register, for example, an account shared by plural users as an authenticated account on a network management device. Accordingly, it is unnecessary to register and manage an account or a MAC address for every user, and thus it is possible to configure a simple system.

Moreover, by way of setting an authenticated account for each of

VLAN groups, it is possible to configure a VLAN as a dynamic VLAN by using a MAC address-based authentication in accordance with a user account a user logged in a manner of a web authentication process or the like.

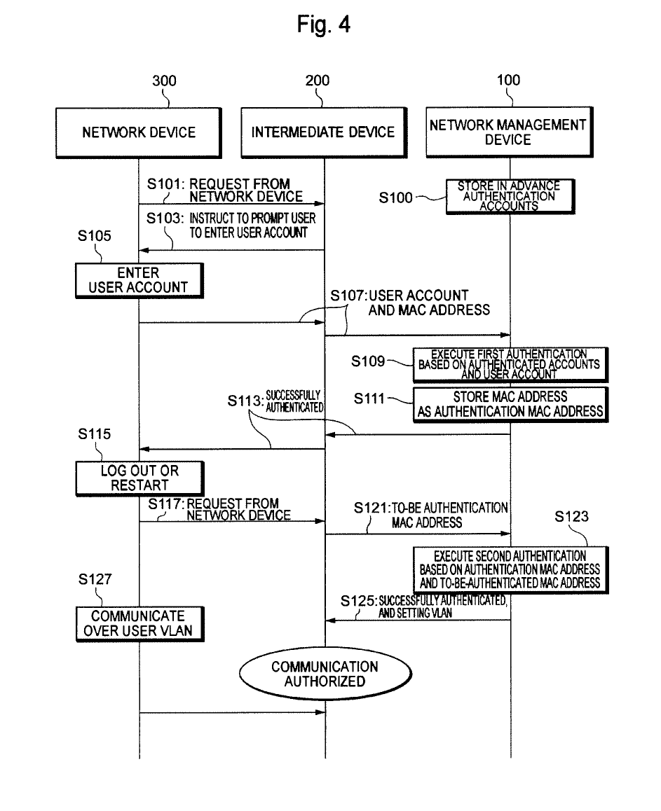

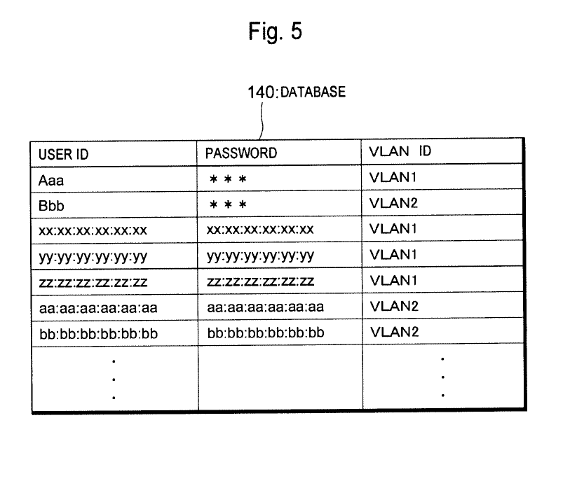

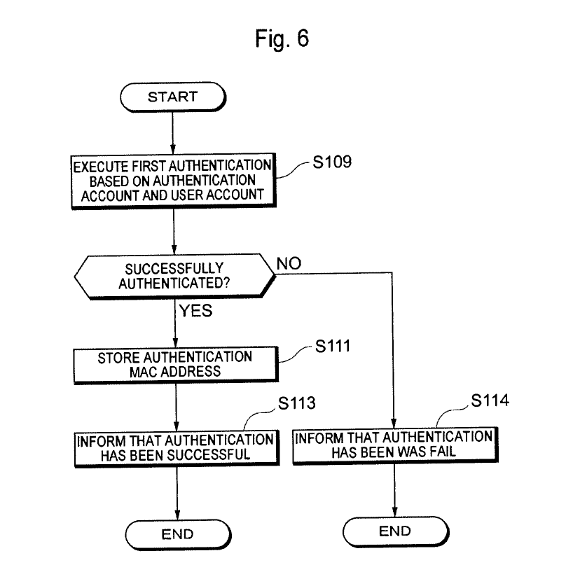

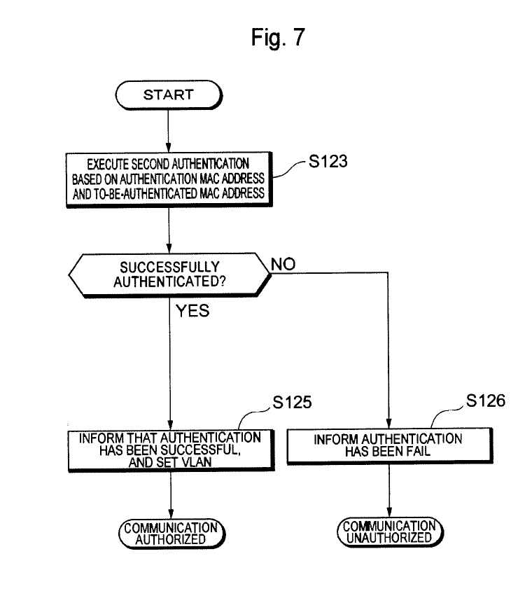

A network management method according to an embodiment of the present invention will be described with reference to FIGS. 4-7. FIG. 4 is a sequence diagram for illustrating a network management method according to an embodiment of the present invention. FIG. 5 is a diagram for showing a database stored in a network management device according to an embodiment of the present invention. FIGS. 6 and 7 are partial flowcharts of the sequence diagram shown in FIG. 4. As an example, the present embodiment will be described below for the situation where a network management method according to the present embodiment is performed by utilizing the above-described system 1000. Each steps explained below (including not only steps denoted by references, but also parts of these steps) may be performed in a manner of changing the order as needed, or in parallel, to the extent that they are consistent with the processes described herein.

First, the network management device 100 stores in advance authentication accounts used for authentication of user accounts provided by users (S 100).

Then, by using one of the network devices 300, a user requests the intermediate device 200 to perform authentication based on the authentication accounts and a user account (S101). More specifically, a user accesses the intermediate device 200 on a network via a web browser by using the network device 300. In response to the request from the network device 300, the intermediate device 200 instructs the network device 300 to prompt a user to enter an account (S103). In this case, the intermediate device 200 may transmit data regarding a login screen for a user to enter a user account to log into the network device 300. It is noted that step S103 may be performed by the instruction unit 210 of the above-described intermediate device 200.

A user then enters user account information, following the instructions on the login screen of the network device 300 (S105). More specifically, a user enters a user ID and a password provided in advance by an administrator into the network device 300. By this, the intermediate device 200 acquires from the network device 300 the user account and a MAC address, which is an example of device identification information on the network device 300, and transmits the user account and the MAC address to the network management device 100 (S107). The acquisition unit 212 and the transmission unit 214 of the network management device 100 may perform the acquisition and transmission of the user account and the MAC address, respectively. The MAC address identified by the network management device 100 may be a MAC address of the network device which receives the request in step S101, or may be a MAC address of a different network device from the network device in step S101. In the latter case, the network management method according to the embodiment can also adopt devices which do not positively access the intermediate device 200 or the network management device 100.

As shown in FIGS. 4 and 6, the network management device 100 performs the first authentication process based on the user account acquired from the network device 300 via the intermediate device 200 and authentication accounts stored in advance in the authentication account storage unit 120 (S109). As a result of the authentication process, if the network device 300 is successfully authenticated, the network management device 100 stores the MAC address of the relevant network device 300 in the authentication device identification information storage unit 130 as an authentication MAC address (S111). Further, the network management device 100 informs the intermediate device 200 and the network device 300 that the network device 300 is successfully authenticated (S113). On the contrary, if the network device 300 is not authenticated, the network management device 100 determines that the access is not authorized by the administrator and informs the intermediate device 200 and the network device 300 that the network device 300 is not authenticated, without storing the MAC address of the relevant network device 300 (S114). It is noted that the first authentication process may be performed by, for example, the above-described first authentication execution unit 112.

The authentication MAC address is stored in the authentication account storage unit 120 in association with the authentication account. In this case, the network management device 100 may create a database 140 in which authentication accounts and authentication MAC addresses are associated with one another under control of the authentication account storage unit 120 and the authentication device identification information storage unit 130 (see FIG. 5). The database 140 includes, as shown in FIG. 5, fields for user IDs, passwords, and VLAN IDs, respectively. The VLAN ID fields hold information for identifying VLAN groups. The user ID fields hold user identification information, which is identification information on a user of the network device. The password fields hold passwords for authenticating users identified by the user identification information. The User ID fields hold authentication accounts (e.g., “Aaa”) that are registered in advance by a system administrator and authentication MAC addresses (e.g., “xx:xx:xx:xx:xx:xx”) that are stored when the first authentication process is executed based on the authentication accounts and a user account. A VLAN group (e.g., VLAN 1 or VLAN 2) is determined for each authentication account that is registered in advance by a system administrator, and an authentication MAC address is stored in association with the relevant VLAN group.

According to the method in the present embodiment, it is possible to authenticate a user ID and a password entered into a network device by using the registered user IDs and passwords, and to register the MAC address of the authenticated network device. Thus, a network administrator can configure a MAC address-based VLAN by registering user IDs and passwords instead of registering MAC addresses, which may be complex character strings, into a database.

Next, a user logs out of, or restarts, the network device 300 which is informed that the first authentication process is successfully authenticated based on the authentication accounts and the user account (S115). Then, a user requests through the relevant network device 300 the intermediate device 200 and the network management device 100 to perform a MAC address-based authentication process. More specifically, a user accesses the intermediate device 200 and the network management device 100 on the network through the network device 300 by using an arbitrary protocol. By this, the intermediate device 200 acquires the to-be-authenticated MAC address of the relevant network device 300 from the network device 300 by using, for example, the acquisition unit 212, and transmits the relevant to-be-authentication MAC address to the network management device 100 by using, for example, the transmission unit 214. The to-be-authenticated MAC address transmitted to the network management device 100 may be the MAC address of the network device which receives the request in step S117, or may be the MAC address of a network device different from the network device in step S117.

Next, as shown in FIGS. 4 and 7, the network management device 100 executes the second authentication process based on the to-be-authenticated MAC address of the network device 300 received via the intermediate device 200 and the authentication MAC addresses stored in authentication account storage unit 120 (S123). By way of this, if the network device 300 is successfully authenticated, the network management device 100 informs the intermediate device 200 and the network device 300 of that authentication, and determines a VLAN, shown in FIG. 5, which is associated with the authentication MAC address (S125). Thus, if a user uses the authentication network device 300 to communicate over a VLAN (S127) since then, communication is authorized by the network management device 100. On the contrary, if the network device 300 is not authenticated, the network management device 100 determines the access is unauthorized and informs the intermediate device 200 and the network device 300 that the network device 300 is not authenticated (S126). Accordingly, it is possible to prevent an unauthorized access to a VLAN. It is noted that the second authentication process may be executed by, for example, the above-described second authentication execution unit 114.

An expiration date indicating that a network device is permitted to communicate over a VLAN is defined in advance, and thereby the network management device 100 may remove from a database the authentication MAC address of the network device whose expiration date has passed. Furthermore, upon a request for deletion of the registration of the network device, a network administrator may delete from a database the MAC address of the network device which the deletion request designates. Thus, if a user desires resetting of a VLAN, further authentication based on a user account and authentication account is required, and thus it is possible to further enhance the security level.

According to the network management method in the present embodiment, since a user logs into an account, and then the MAC address of the logged-in network device is stored as an authenticated MAC address used for a MAC address-based authentication, it is possible to execute a MAC address-based authentication process without further entry of a MAC address by a user. Thus, a network administrator does not have to register in advance MAC addresses of network devices on a network management device, and thus it is possible to configure a MAC address-based VLAN easily. Meanwhile, since, in order to store a MAC address of a network device, the account should be authenticated when logged in, it is possible to prevent unauthorized access to a VLAN. In other words, the level of security during the period in which a MAC address is stored as an authenticated MAC address used for a MAC address-based authentication can be improved.

Furthermore, even if a user needs to change a network device, in the network device changed, it is enough to perform a first authentication process based on a user account and authentication accounts and to perform a second authentication process based on authentication MAC addresses and to-be-authenticated MAC addresses. Accordingly, there is no hassle of working on a request for communication authorization of an administrator or registration of a user account by an administrator, thereby allowing a network system to be utilized in a simple and highly-secure way.

As a variation of the system or method according to the above-described embodiment, a DHCP (Dynamic Host Configuration Protocol) snooping of the intermediate device 200 may also be adapted to prevent false MAC addresses. More specifically, the intermediate device 200 or the controller 110 of the network management device 100 monitors a DHCP frame, and thereby the one may permit communication which depends on combination of an IP address assigned by a proper DHCP server and a MAC address.

Moreover, if the first authentication process based on a user account and an authentication account according to the embodiment is successful, a virus scan or asset information collection/management may be performed on the authenticated network device. In this case, a VLAN group for virus scans or a VLAN for asset information management is configured in advance as a VLAN group assigned based on the authentication MAC address, and thereby, with respect to a network device which requires a virus scan or asset information management, a VLAN group appropriate for the purpose may be assigned by the MAC address-based authentication.

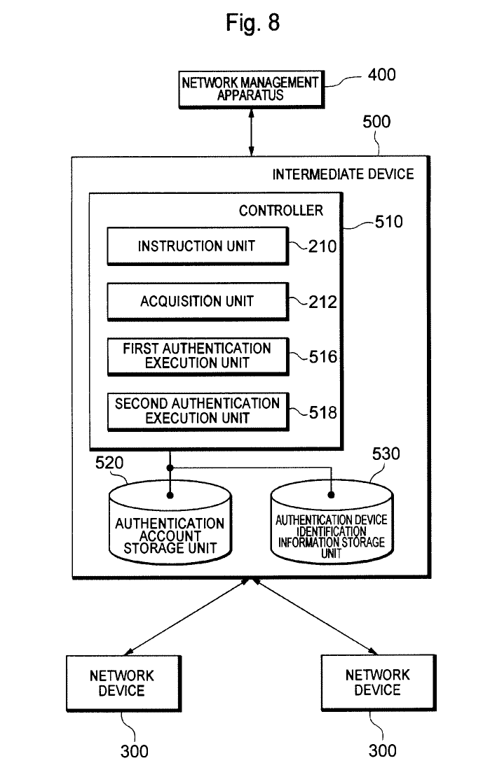

An intermediate device according to another embodiment of the present invention will be described below. As shown in FIG. 8, in this embodiment, an intermediate device 500 is provided so as to connects a network device 300 and a network management device 400, and includes configuration equivalent to functional blocks specified by the first authentication execution unit 112, the second authentication execution unit 114, the authentication account storage unit 120, and the authentication device identification information storage unit 130 as described above. More specifically, the intermediate device 500 is provided with, in addition to the instruction unit 210 and the acquisition unit 212 as described above, a controller 510 including a first authentication execution unit 516 and a second authentication execution unit 518, an authentication account storage unit 520, and an authentication device identification information storage unit 530. With respect to the configuration and operation of the functional blocks thereof, the aforementioned explanation can be applied, except that the functional blocks are embedded in the intermediate device 500, not the network management device, and thereby the data source and destination are modified.

As described above in the present embodiment, it is possible to provide a simple and highly-secure system and method.

The examples and applications explained using the above-described embodiment of the invention can be utilized by either arbitrarily combining or making changes or improvements to same in accordance with the use, and the present invention is not limited to the disclosure of the above-described embodiment. It is anticipated from the disclosure of the claims that implement that adds a combination, or change or improvement like this can also be within the scope of the present invention.

What is claimed is:

1. A network management method in a computer network system including a network device, a network management device managing the network device, and an intermediate device operatively connecting the network device with the network management device, the method comprising:
storing, by the network management device, an authentication account for authenticating the network device;
instructing, by the intermediate device, the network device to prompt a user to enter a user account;
acquiring, by the intermediate device, the user account and device identification information relating to the network device from the network device;
transmitting, by the intermediate device, the user account and the device identification information to the network management device;
performing, by the network management device, a first authentication process for the network device based on the authentication accounts and the user account; and
storing, by the network management device, if the network device is authenticated in the first authentication process, the device identification information as authentication device identification information.

2. The method according to claim 1, further comprising:
after the storing of the device identification information, acquiring, by the intermediate device, device-to-be-authenticated identification information from the network device, the device-to-be-authenticated identification information being device identification information about the network device;
transmitting, by the intermediate device, the device-to-be-authenticated identification information to the network management device; and
performing, the network management device, a second authentication process for the network device based on the authentication device identification information and the device-to-be-authenticated identification information.

3. The method according to claim 2, further comprising, prior to the acquisition of the device-to-be-authenticated identification information, requesting, by the network device, the intermediate device to perform the second authentication process in the network management device.

4. The method according to claim 2,
wherein the storing of the authentication account includes storing the authentication account in association with a predetermined VLAN group,
the method further comprising:
after the second authentication process, setting, by the network management device, if the network device is authenticated, a VLAN group for the network device.

5. The method according to claim 1, wherein the instruction of the intermediate device is performed when the network device requests the intermediate device to perform the first authentication process in the network management device.

6. The method according to claims 1, wherein the authentication account is an account shared by a plurality of users.

7. The method according to claim 1, wherein the device identification information is a MAC address of the network device.

8. A computer readable storage medium storing a computer program including instructions to cause a computer to perform the network management method according to claim 1.

9. A network system comprising:
a network device;
a network management device configured to manage the network device; and
an intermediate device configured to operatively connect the network device and the network management device,
wherein the intermediate device includes:
an instruction unit configured to instruct the network device to prompt a user to enter a user account;
an acquisition unit configured to acquire the user account and device identification information about one of the network devices from the network device; and
a transmission unit configured to transmit the user account and the device identification information to the network management device, and
wherein the network management device includes:
an authenticated account storage unit configured to store an authentication account used for authenticating the network device;
a first authentication execution unit configured to authenticate the network device based on the authentication account and the user account; and
an authentication device identification information storage unit configured to store the device identification information as authentication device identification information if the network device is authenticated by the first authentication execution unit.

10. The network system according to claim 9,
wherein the acquisition unit of the intermediate device acquires device-to-be-authenticated identification information from the network device, the device-to-be-authenticated identification information being device identification information about the network device, and
wherein the network management device further includes a second authentication execution unit configured to authenticate the network device based on the authentication device identification information and the device-to-be-authenticated identification information.

11. An intermediate device connecting a network device and a network management device which manages the network device, the intermediate device comprising:
an authenticated account storage unit configured to store an authentication account used for authenticating the network device;
an instruction unit configured to instruct the network device to prompt a user to enter a user account;
an acquisition unit configured to acquire the user account and device identification information about the network device from the network device;
a first authentication execution unit configured to authenticate the network device based on the authentication account and the user account; and
an authentication device identification information storage unit configured to store the device identification information as authentication device identification information if the network device is authenticated by the first authentication execution unit.

12. The intermediate device according to claim 11,
wherein the acquisition unit acquires device-to-be-authenticated identification information from the network device, the device-to-be-authenticated identification information being device identification information about the relevant network device, and
wherein the intermediate device further includes a second authentication execution unit configured to authenticate the network device based on the authentication device identification information and the device-to-be-authenticated device identification information.
